(19) United States
(12) Patent Application Publication
(10) Pub. No.: US 2024/0326838 A1
(43) Pub. Date: Oct. 3, 2024

(54) OPTIMIZED DIAGNOSTIC MODEL USING VEHICLE DATA

(71) Applicant: CUMMINS INC., Columbus, IN (US)

(72) Inventors: Anshaj Chadha, Columbus, IN (US); Fatiha Anouar, Columbus, IN (US); Thomas Lynn McKinley, Columbus, IN (US); Vikas Narang, Columbus, IN (US); Greesham Anand, Columbus, IN (US)

(73) Assignee: CUMMINS INC., Columbus, IN (US)

(21) Appl. No.: 18/694,927

(22) PCT Filed: Sep. 30, 2022
(86) PCT No.: PCT/US2022/045364

§ 371 Date: Mar. 22, 2024

Related U.S. Application Data
(60) Provisional application No. 63/251,428, filed on Oct. 1, 2021.

(51) Int. Cl. B60W 50/02; B60W 50/035

(52) U.S. Cl. CPC B60W 50/0205; B60W 50/035

(57) ABSTRACT

Systems, devices, and methods for optimizing troubleshooting procedures for vehicles are disclosed herein. A system includes a processor and a memory storing executable instructions. The executable instructions, when executed by the processor, cause the processor to: obtain in-operation data of a vehicle, the in-operation data including a fault code indicative of a fault in the vehicle; identify a trained model from a plurality of trained models using the fault code; use the trained model and the in-operation data of the vehicle to generate a troubleshooting procedure for identifying a root cause of the fault; and provide the troubleshooting procedure as output to identify the root cause of the fault.

### CROSS-REFERENCE TO RELATED PATENT APPLICATION

This application claims the benefit of and priority to U.S. Provisional Patent Application No. 63/251,428 filed Oct. 1, 2021, titled “OPTIMIZED DIAGNOSTIC MODEL USING VEHICLE DATA,”, and incorporated herein by reference in its entirety.

### TECHNICAL FIELD

The present disclosure relates to systems, apparatuses, and methods for optimizing diagnostic models using vehicle data. Specifically, the various embodiments disclosed herein relate to systems, apparatuses, and methods for using engine performance data, after treatment performance data and/or health data to provide relatively faster and more efficient service troubleshooting procedures.

### BACKGROUND

On-board diagnostics (OBD) technology allows for diagnosis or detection of defects in a vehicle. However, the OBD detection or diagnosis is a system level diagnosis, and generated fault codes indicate systems associated with the defect but do not identify the failing component in the affected system. To identify the root cause component (or root cause failure), a technician executes a standard troubleshooting process. For some fault codes, the corresponding troubleshooting process can involve a larger number of troubleshooting steps and/or complex steps. In many cases the troubleshooting process can be cumbersome and costly.

### SUMMARY

One embodiment relates to a system comprising a processor and a memory storing executable instructions. The executable instructions, when executed by the processor, cause the processor to obtain in-operation data of a vehicle. The in-operation data includes a fault code indicative of a fault in the vehicle. The processor identifies a trained model from a plurality of trained models using the fault code. The processor uses the trained model and the in-operation data of the vehicle to generate a troubleshooting procedure for identifying a root cause of the fault. The processor provides the troubleshooting procedure as an output to identify the root cause of the fault.

Another embodiment relates to a method including a data processing system obtaining in-operation data of a vehicle, the in-operation data including a fault code indicative of a fault in the vehicle. The method may include the data processing system identifying a trained model from a plurality of trained models using the fault code. The method may include the data processing system using the trained model and the in-operation data of the vehicle to generate a troubleshooting procedure for identifying a root cause of the fault. The method can include providing the troubleshooting procedure as an output to identify the root cause of the fault.

Yet another embodiment relates to a non-transitory computer readable medium having computer executable instructions embodied therein that, when executed by one or more processors of a computing system, cause the computing system to: obtain in-operation data of the vehicle, the in-operation data including a fault code indicative of a fault in the vehicle; identify a trained model from a plurality of trained models using the fault code; generate a troubleshooting procedure for identifying a root cause of the fault based on the trained model and the in-operation of the vehicle; and provide the troubleshooting procedure as an output for use to identify the root cause of the fault.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Additionally, one or more features of an aspect of the invention may be combined with one or more features of a different aspect of the invention.

### BRIEF DESCRIPTION OF THE FIGURES

FIG. 1 is a block diagram illustrating a service process for a vehicle is shown, according to an example embodiment;

FIG. 2 is a diagram illustrating an overview of an optimized vehicle diagnosis process based on optimized diagnosis models, according to an example embodiment;

FIG. 3 is a diagram illustrating a data flow scheme of an optimized diagnosis process for a vehicle, according to an example embodiment;

FIG. 4 shows a flowchart illustrating a method of training and using optimized diagnostic models, according to an example embodiment;

FIG. 5 shows a diagram illustrating an example air handling system 500 and a corresponding fault isolation problem, according to an example embodiment;

FIG. 6 show a flowchart illustrating a method for providing optimized or customized troubleshooting procedures, according to an example embodiment;

FIGS. 7A and 7B show two sets of features or parameters for distinguishing between different sets of failures, according to an example embodiment; and

FIG. 8 shows charts illustrating the financial impact as well as impact on customer experience of using the optimized diagnostic models.

FIG. 9 shows a schematic diagram of a computer environment for implementing processes described herein, according to an example embodiment.

### DETAILED DESCRIPTION

Following below are more detailed descriptions of various concepts related to, and implementations of, methods, apparatuses, and systems for optimizing diagnostic models using vehicle data. Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring to the figures generally, the various embodiments disclosed herein relate to systems, apparatuses, and methods for optimizing diagnostic models using vehicle data. Specifically, the various embodiments disclosed herein relate to systems, apparatuses, and methods for using at least one of engine performance data, aftertreatment performance data or health data to provide relatively faster and more efficient service troubleshooting models procedures.

When diagnosing a vehicle to identify or assess problems that may negatively affect the normal operation of the vehicle, the troubleshooting procedures for each fault code usually follow a standard troubleshooting tree for that fault code that is fixed and inflexible. As used herein, a fault code refers to a system level failure while a failure code refers to a component level failure. A system can include a plurality of components, and a corresponding fault code can be associated with any of multiple failure codes. When a fault code is triggered indicating a potential problem, a corresponding standard troubleshooting tree is usually used to identify the root cause or the faulty component.

For many fault codes, the corresponding troubleshooting process or tree may be cumbersome (e.g., with respect to the total number and/or complexity of steps involved) and difficult to troubleshoot. For such fault codes, technicians tend to perform or execute all the steps of the standard tree according to the standard order, which leads to relatively long diagnosis time and higher labor cost. The diagnosis process described by the standard troubleshooting tree does not take into account vehicle data except for the fault code. For instance, the order of the diagnosis steps provided by the standard tree is not necessarily the order that would result in the quickest identification of the root cause component. Also, depending on the history data of the vehicle, not all diagnosis or troubleshooting steps may be needed. These facts make existing vehicle diagnosis approaches labor intensive and therefore costly to execute.

The current disclosure and embodiments herein allow for faster, more efficient and more accurate service troubleshooting procedures using at least one of engine performance, aftertreatment performance data or health data. Systems, apparatuses and methods for vehicle diagnosis described herein make use of on-road/in-operation measurements or data of the vehicle before and after fault code activation to identify the root cause component. Specifically, the systems, apparatuses and methods described herein can provide the on-road/in-operation measurements or data as input to a trained troubleshooting model (also referred to herein as an analytics model, a classification model or a prediction model), which determines and outputs an optimized or customized troubleshooting procedure to be used to identify the root cause component that triggered the fault code. The troubleshooting steps in the optimized or customized troubleshooting procedure and/or the respective order depend on the vehicle's on-road/in-operation measurements or data fed to the trained model.

The on-road/in-operation measurements or data may have, but is not limited to, a relatively low time resolution. For instance, the on-road/in-operation measurements or data can include trip summary data collected before and/or after the fault code activation. A trip as used herein refers to a time window that begins with starting the vehicle engine (key-on) and ends when the engine is turned off (key-off). A data processing system can filter the trip summary data before passing it to a classification or prediction model. The model can predict which component(s) are or are not likely the root cause of the fault code and in some instances the probability that this assessment is correct. The on-road/in-operation measurements or data as described herein is not limited to trip summary data can have different time resolution The on-road/in-operation measurements or data can be generated and received from and array of sensors and embedded models of the vehicle.

The benefits of the embodiments described herein include lower warranty costs by reducing labor expense and “trouble not found” parts replacements. They have the additional benefit to customers of reducing repeat repairs for those cases where the root cause component was not correctly identifies. This reduction in customer pain contributes to improved customer satisfaction and thereby market share.

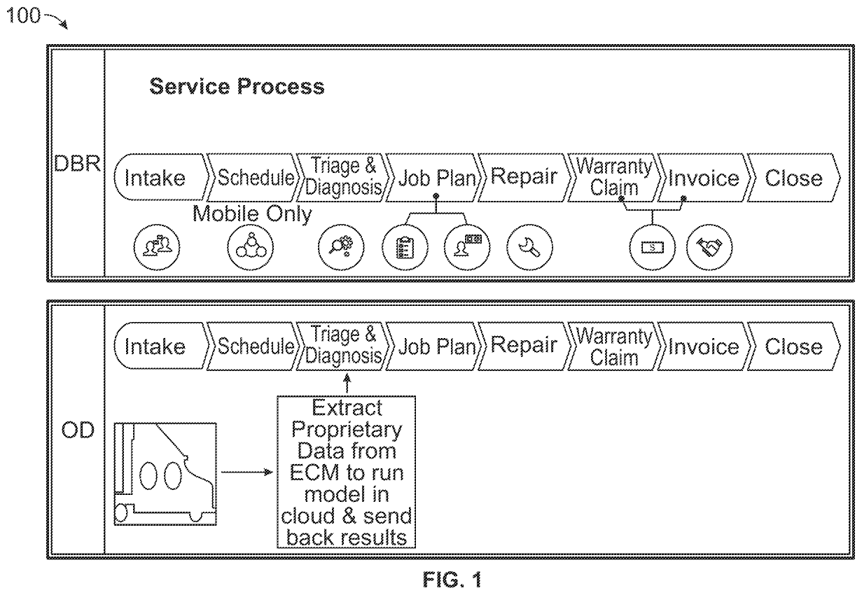

Referring now to FIG. 1, a block diagram illustrating a service process 100 for a vehicle is shown, according to an example embodiment. The service process 100 can include a sequence of steps that are described for both diagnostic based repair (DBR) and optimized diagnosis (OD). As used herein, DBR refers to conventional approaches of servicing or repairing vehicles, while OD refers to the use of optimized diagnostic models described as discussed in this disclosure. The service process 100 can include an intake step, a scheduling step, a triage and diagnosis step, a job planning step, a repair step, a warranty claim step and an invoicing step. All the steps of the service process 100 can be similar for diagnostic based repair (DBR) and optimized diagnostic (OD) repair, except for the triage and diagnosis step.

During the intake step, a service advisor greets a customer and may take the vehicle information. The scheduling step can include the service advisor adding the vehicle to a queue of vehicles to be services and/or repaired. In DBR, the triage and diagnosis step can include a technician running or executing a standard sequence or tree of troubleshooting steps associated with one or more fault codes. In OD repair, the triage and diagnosis step can include the technician extracting or retrieving in-operation measurements or data from the vehicle and uploading the in-operation measurements or data to a data processing system (e.g., in the cloud). The on-road/in-operation measurements or data can be generated by array of sensors and embedded models of the vehicle and collected by a data log device of the vehicle. The data processing system can identify a trained model based on the one or more fault codes and run the trained model using the uploaded in-operation measurements or data as input. The trained model, when executed with at least part of the in-operation measurements or data as input, can generate an optimized or customized sequence or tree of troubleshooting steps that is communicated to the technician. The technician can execute the optimized or customized sequence of troubleshooting steps to identify a root cause component of the problem associated with the one or more fault codes.

During the job plan step, the technician can develop a repair plan based on the identified root cause component and communicate a quote of the repair cost to the customer. If the customer approves the repair plan and the repair cost, the technician can repair the vehicle according to the repair plan during the repair step. In the warranty claim step, the technician or other service advisor can record a description of the diagnosis and repair made in a database, and communicate any warranty claim on the repair to the customer. During the invoice step, an invoice of the repair cost can be provided to the customer, and the customer can pay for the repair. Finally during the close step, the service advisor can close any files related to the customer and end the service process 100.

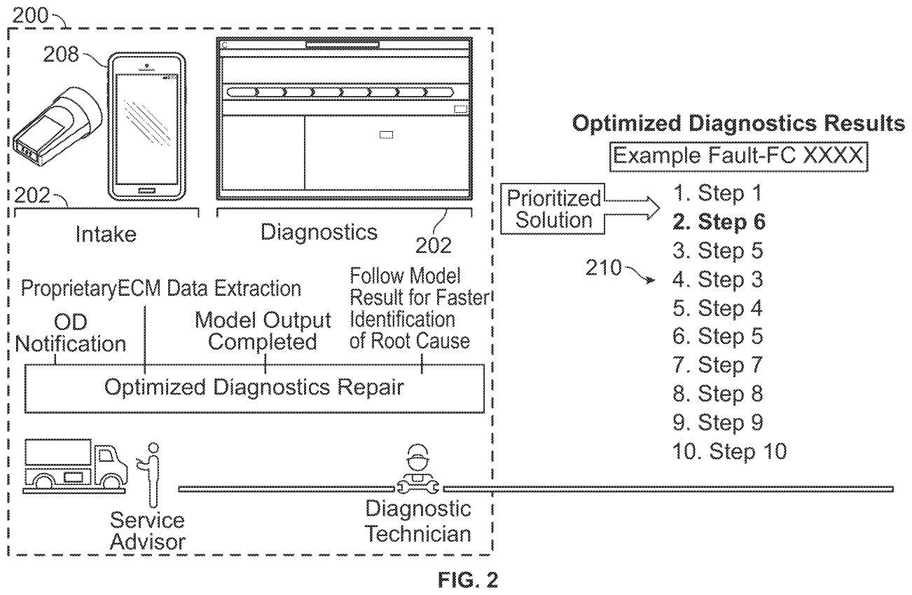

Referring now to FIG. 2, a diagram illustrating an overview of an optimized diagnosis process 200 for a vehicle based on optimized diagnosis models is shown, according to an example embodiment. The optimized diagnosis process 200 can be viewed as including two phases; an intake phase 202 during which the service advisor uses a data processing system to develop an optimized or customized troubleshooting plan or sequence, and a diagnostics phase 204 during which the technician executes the optimized or customized troubleshooting plan or sequence.

During the intake phase 202, the service advisor can get an optimized diagnostics notification on a computing device, for example, upon entering the vehicle information. The optimized diagnostics notification can instruct the service advisor to extract or retrieve in-operation measurements or data from the vehicle 206. The vehicle 206 can include a data collection component configured to collect and record measurements from various sensors of the vehicle 206. The data collection component can include a storage device and a software module configured to receive sensor measurements and store the sensor measurements in the storage device. In some implementations, the data collection component can record timestamps indicative of the start and end of each trip as well as timestamps indicative of the times at which measurements are taken. In some implementations, the software module can record or store each measurements in association with a corresponding trip.

The service advisor can retrieve the in-operation measurements or data from the vehicle 206 using an electronic device 208, such as a mobile device. For instance, the service advisor can make a copy of the in-operation measurements or data on the electronic device 208. The in-operation measurements or data can include fault codes that were activated in the vehicle, e.g., due to detected faults or problems. In some implementations, the retrieved in-operation measurements or data can include timestamps of indicative of time windows representing different trips, time instances at which measurements were taken and/or time instances at which fault codes were activated in the vehicle 206. In some implementations, the retrieved in-operation measurements or data can include other indications (e.g., other than the timestamps) indicative of associations between measurements and corresponding trips or time windows.

The service advisor can upload the in-operation measurements or data retrieved or copied from the vehicle 206 to a data processing system, e.g., on the cloud. The data processing system can include one or more computing devices, such as computer servers. The data processing system can include one or more processors and at least one memory storing computer code instructions. The computer code instructions when executed by the one or more processors can cause the one or more processors to perform methods described in this disclosure. For instance, each computing device in the data processing system can include at least one processor and at least one memory.

The data processing system can use the in-operation measurements or data and a trained diagnostics model to generate an optimized or customized troubleshooting sequence, such as the troubleshooting sequence 210. The data processing system can generate the troubleshooting sequence 210 for identifying a root cause component associated with an activated fault code, such as the fault code “FC XXXX” or other fault code. The troubleshooting sequence 210 can include the all the steps the standard trouble shooting tree for the fault code but in a different order. In some implementations, the troubleshooting sequence 210 can include a subset of the steps in the standard trouble shooting tree for the fault code. In some implementations, the data processing system can determine for each troubleshooting step in the troubleshooting sequence 210 a corresponding confidence probability indicative of the probability that the root cause component is associated with that troubleshooting step. The troubleshooting sequence 210 can include for each troubleshooting step the corresponding confidence probability. The troubleshooting steps in the troubleshooting sequence 210 can be ordered according to a descending order of confidence probabilities. Such order allows for faster identification of the root cause component. It should be understood that the example “Step 1” through “Step 10” text is used in FIG. 2 to represent hypothetical steps, such as running the engine at a certain speed or load, checking a coolant temperature or level, stopping EGR intake, etc.

The data processing system can provide the trouble shooting sequence 210 as output. In the diagnostics phase, the diagnostic technician can execute the trouble shooting sequence 210 to identify the root cause component. In some implementations, the diagnostic technician may not complete the whole trouble shooting sequence 210 and may stop once the root cause component is identified. Once the root cause component is identified, the technician may move to the next repair step (e.g., job plan step) as discussed above with regard to FIG. 1. In some instances, one or more of the steps of the sequence may be automatically performed upon receipt of an instruction from a technician (e.g., the technician approves the step and, in turn, the data processing system sends an instruction to the engine to or other vehicle component to operate in accordance with the associated step in the sequence).

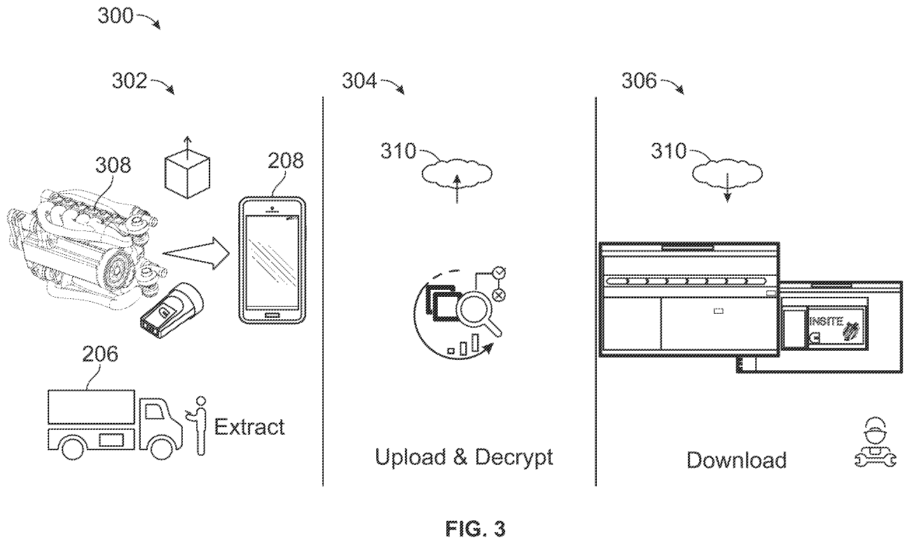

Referring now to FIG. 3, a diagram illustrating a data flow scheme 300 of an optimized diagnosis process for a vehicle is shown, according to an example embodiment. The data flow scheme 300 can include three major phases or steps 302, 304 and 306. In a first phase (also denoted as data extraction phase) 302, the electronic device 208 can extract, retrieve or copy in-operation measurements or data from the vehicle 206. The in-operation measurements or data can include performance and/or health data of the engine 308 of the vehicle 206. As discussed above with regard to FIG. 2, the in-operation measurements or data can include sensor measurements, fault codes that were activated in the vehicle 206, indications of different trips (e.g., timestamps indicative of boundaries of each time windows corresponding to a respective trip), information indicative of associations between sensor measurements and/or fault codes with corresponding trips or a combination thereof.

During a second step (also referred to as upload and decrypt step) 304, the electronic device 208 can upload the in-operation measurements or data of the vehicle to a data processing system. The data processing system may be hosted in the cloud 310. The in-operation measurements or data of the vehicle may be uploaded in an encrypted form. The data processing system can decrypt the in-operation measurements or data of the vehicle once received.

In a third step (also referred to as download step) 306, the electronic device 208 or other computing device can download an optimized (or customized) troubleshooting sequence from the data processing system. As discussed above, the data processing system can generate the optimized (or customized) troubleshooting sequence using a trained model and the in-operation measurements or data of the vehicle. The optimized (or customized) troubleshooting sequence can include a sequence of troubleshooting steps ordered according to descending confidence probabilities to increase the likelihood that the root cause component is identified in the first few steps of the sequence.

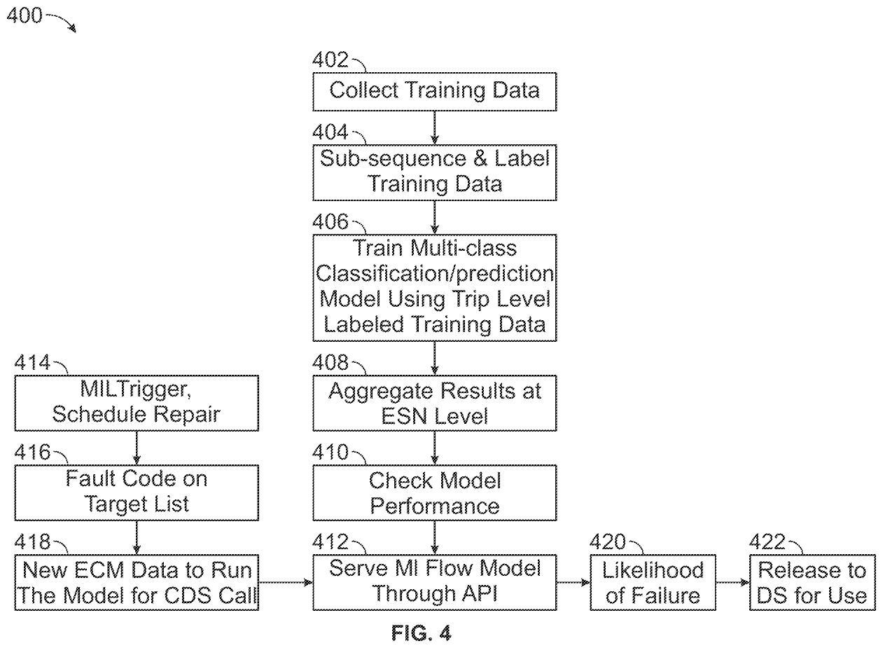

Referring now to FIG. 4, a flowchart illustrating a method 400 of training and using optimized diagnostic models is shown, according to an example embodiment. The method 400 can include the data processing system obtaining or collecting historical information of a plurality of vehicles (STEP 402). The historical information can include engine electronic control module (ECM) data, warranty claims and/or diagnostic system (DS) repair claims, among others. The ECM data can include engine performance data or parameters, after treatment performance data or parameters, duty cycle information, ambient condition parameters or a combination thereof, among others. Warranty claims can include historical repair information, such as dates of repair, recorded failures and repairs made, technician comments, cost of each repair, fail code(s) assigned to each problem or a combination thereof. It is to be noted that a fault code can have (or can be associated with) multiple fail codes. For example, fault code XXXX can be indicative of turbocharger failure, an EGR cooler failure and/or a leak failure. Each of these failures has a separate fail code. The data processing system can obtain the warranty claims from one or more databases storing. The DS data can include diagnostic results or steps, for example, associated with different repair events or fault codes. The data processing can generate or create training files using the ECM data, the warranty claims and/or the DS data. For instance, the data processing system can match historical repair claims (from warranty claims) and/or diagnostic results from DS data to corresponding ECM data sets. For example, ECM data recorded some time period prior to a repair or diagnosis event can be mapped to the repair claim or diagnosis result associated with the repair or diagnosis event.

The method 400 can include sub-sequencing and labeling the training data (STEP 404). The ECM data can be key cycle (or trip) based data. Specifically, the ECM data can be trip summary (or average) data rather than second by second data. The use of trip summary data results in a data compression factor advantage compared to using second by second data. The data processing system can label the trip summary data with corresponding failures or fail codes. The data processing system may apply filtering to the trip summary data. For instance, some trips may not be valuable to the model to be trained. The data processing system can apply filtering to eliminate trips which are not of interest (e.g. engine not running). The data processing system can reduce data associated with remaining trips by various techniques, e.g., calculation of mean and standard deviation, range, maximum, minimum, to form parameters that reflect the equipment's operating condition during the time window of interest. These reduced parameters are used to represent the equipment's condition as a point within an n-dimensional space. The data processing system may apply some rules when selecting trip summary data to be used as input for training a given model. These rules may impose that the trip summary data should not include gaps equivalent to an X amount of data (or more) that is missing. The rules may also impose that the trip summary data to be used should include a Y amount (e.g., as a percentage of the ECM data to be used) of certain type(s) of data, for example, to impose a relatively high drive time. For instance, trip summary data associated with a trip where the engine was started and then turned off while the vehicle stayed idle (did not move) may not be valuable data for some models. The mapping of trip summary data (including fault codes) to correct component failures (or corresponding fail codes) results in labeled training data that can be used to train optimized troubleshooting models.

The method 400 can include the data processing training one or more multi-class classification or prediction models using trip-level labeled training data (STEP 406). The data processing system can use the labeled training data to train a plurality of classification or prediction models (also referred to as analytics models). The scope of each model can be defined by one or more fault codes, one or more fail codes or a combination thereof Δn analytics model can subdivide regions of the n-dimensional space and associate them with component(s) that are or are not likely root cause components for the fault code(s). The association can be through defined n-dimensional boundaries such as hyperplanes or surfaces, or by considering regions as overlapping probability distributions. In the former case, the model output can be which component is, or which component are not, the root cause of the fault code(s). In the latter case, the model output can be the probability that a given component is or is not the root cause of the fault code.

In some implementations, each model can be configured to output, based on input trip summary data, an ordered list of possible fail codes or root cause components/failures associated with one or more fault codes. The list can be ordered according to decreasing component failure probabilities. In some implementations, a model may be configured to determine component failure probabilities for a plurality of fail codes (or corresponding failures or root cause components). The models can include regression models, neural networks or other types of machine learning models. During the training process, the data processing system can determine the parameters defining each model. As illustrative example, the trained models may include a NOx sensor model configured to detect engine out sensor failure or system out sensor failure. The trained models may include an exhaust gas recirculation (EGR) cooler model configured to detect EGR cooler failure.

In some implementations, the trained models may have the same type or framework (e.g., all models are regression models or all models are neural networks) but configured or designed to receive different input data. In some implementations, the data processing system can train the models using trip summary (or average) data rather than second by second data. This leads to a data compression factor advantage compared to using second by second data. The trained model can be viewed as statistical models. Also with regard to the input data, each model may be configured to receive a separate subset of features of the collected data. In other words, the subset of features fed to one model can be different from the subset of features fed to another model. The use of low time resolution data (e.g., using trip summary (or average) data rather than second by second data) allows for using a large number of features as input without (e.g., tens or few hundreds) while maintaining a reasonable model complexity. The use of a rich set of features usually results in higher prediction accuracy.

The method 400 can include aggregating results at ESN level (STEP 408) and checking model performance (STEP 410). The data processing system can test or assess the performance of the trained models by assigning probability of failures to key cycles. The data processing system can apply some checks to model probability data, such as whether the vehicle had enough driving time, whether it was running at the right window, whether there was enough data before and after the fault code was triggered in the vehicle and/or whether there was enough engine run time to have a likelihood of component failure that can be provided as output.

Once the training models are tested, the data processing system can provide the trained model(s) for access via APIs (STEP 412). The models can be accessed for use in a deployment phase to generate troubleshooting procedures or sequences based on input in-operation data retrieved from a vehicle to be diagnosed. For instance, a fault code may be triggered in vehicle (STEP 4141). A service advisor may check whether the triggered fault code is one for which there is a trained analytics model (STEP 416). If the answer is yes, the service advisor can retrieve the in-operation data of the vehicle to run the analytics model (STEP 418). Upon running the model with retrieved vehicle data, the data processing system can generate the likelihood of failure of each component (STEP 420), and provide the results to the diagnosis system (STEP 422) to execute a corresponding sequence of troubleshooting steps. The troubleshooting steps can be associated with different components and ordered according to decreasing order of likelihood of failure. In other words, a component with a higher probability or likelihood of failure would be troubleshot before another component with a lower probability or likelihood of failure.

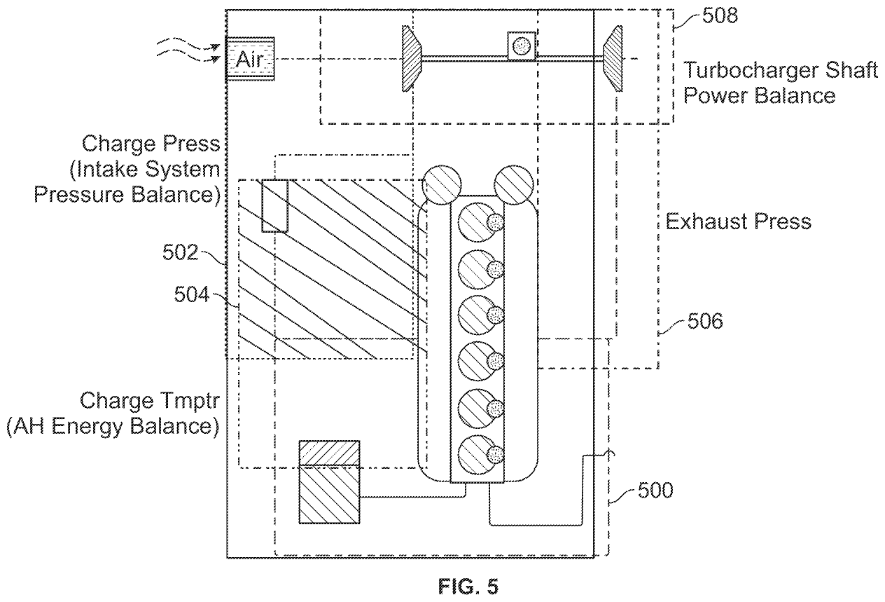

FIG. 5 shows a diagram illustrating an example air handling system 500 and a corresponding fault isolation problem, according to an example embodiment. The system 500 includes a plurality of components. A failure in any of these components will trigger the fault code 3382 indicative of an error related to low exhaust gas flow. Fault codes are generated by the on-board diagnostic (OBD) system of the vehicle. The OBD system level diagnostics use signals from multiple components of each system. As such, a failure in any of the components whose signals are used by OBD system level diagnostics will trigger a fault or corresponding fault code. When a system-level fault occurs (e.g., the corresponding fault code is triggered), it is unclear which component or part of the system needs to be fixed. In the case of the air handling system 500, one cannot infer from the fault code XXXX which component of the air handling system 500 has failed. In fact, it could be any component whose signals are used by OBD system level diagnostics to detect a low flow error and trigger the XXXX fault code.

Also, due to overlaps in signals used by OBD system level diagnostics, many of the monitors can be highly cross sensitive to failures. For example, the systems (or subsystems) 502, 504, 506 and 508 overlap with each other and with the air handling system 500. Each of these systems can have a separate fault code that is triggered when a component in that system fails. When a component is shared by two or more overlapping systems, its failure can trigger fault codes associated with the two or more overlapping systems. Also with respect to each system, the larger is the system, the more difficult and more complex the fault isolation becomes.

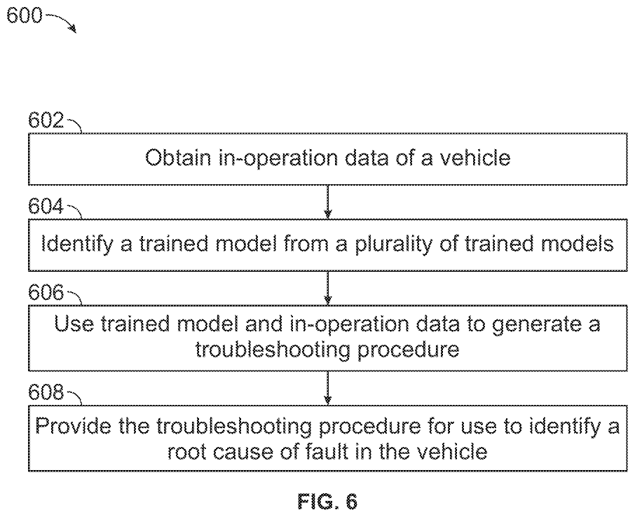

Referring to FIG. 6, a flowchart illustrating a method 600 for providing optimized or customized troubleshooting procedures, according to an example embodiment. The method 600 can include obtaining or receiving in-operation data of a vehicle (STEP 602), and identifying a trained model from a plurality of trained models (STEP 604). The method 600 can include using the trained model and the in-operation data of the vehicle to generate a trouble shooting procedure for a fault in the vehicle (STEP 606). The method 600 can include providing the troubleshooting procedure as output for use to identify a root cause of the fault in the vehicle (STEP 208). The method 600 is described in further detail below taking into account the discussion above with regard to FIGS. 1-5.

The method 600 can include the data processing system obtaining or receiving in-operation data of a vehicle (STEP 602), and identifying a trained model from a plurality of trained models (STEP 604). The data processing system can receive the in-operation data from a database (e.g., if vehicle transfers its data regularly to a remote database) or as input when uploaded by a service advisor. The in-operation data can be key cycle (or trip) based data. The data processing system can preprocess or filter the in-operation data of the vehicle as discussed above, with regard to FIG. 4, so that the processed data represents trip summary (or average) data that satisfies some predefined rules or conditions.

The in-operation data of the vehicle can include one or more fault codes. The data processing system can use the one or more fault codes to identify one or more analytics models to be run. For instance, each model ca be associated with one or more corresponding fault codes. The data processing system can maintain a data structure storing the association between each fault code and the corresponding analytics model. The data processing system can use the data structure and the one or more fault codes extracted from the in-operation data of the vehicle to identify the analytics model(s) to be run.

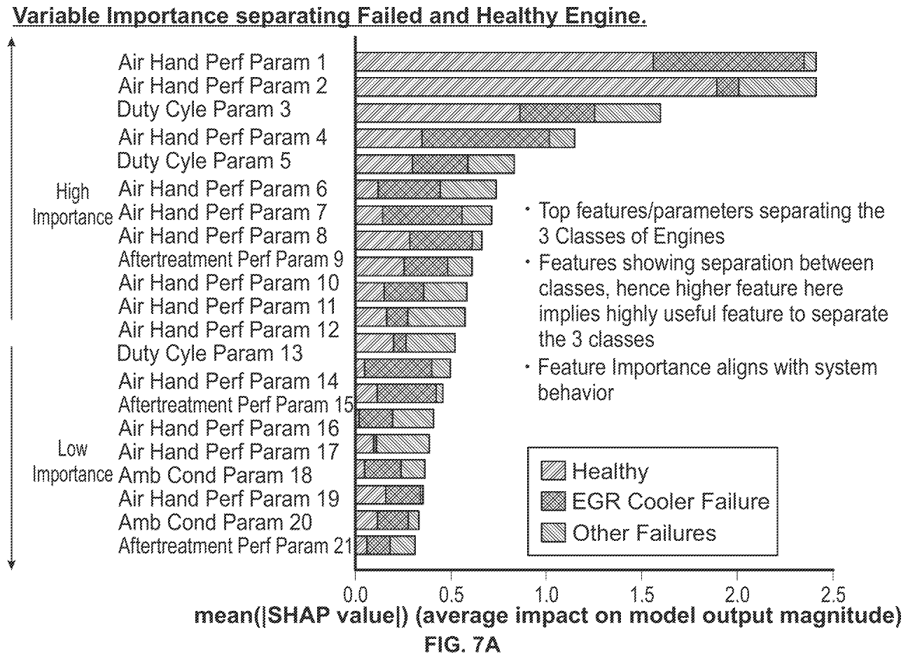

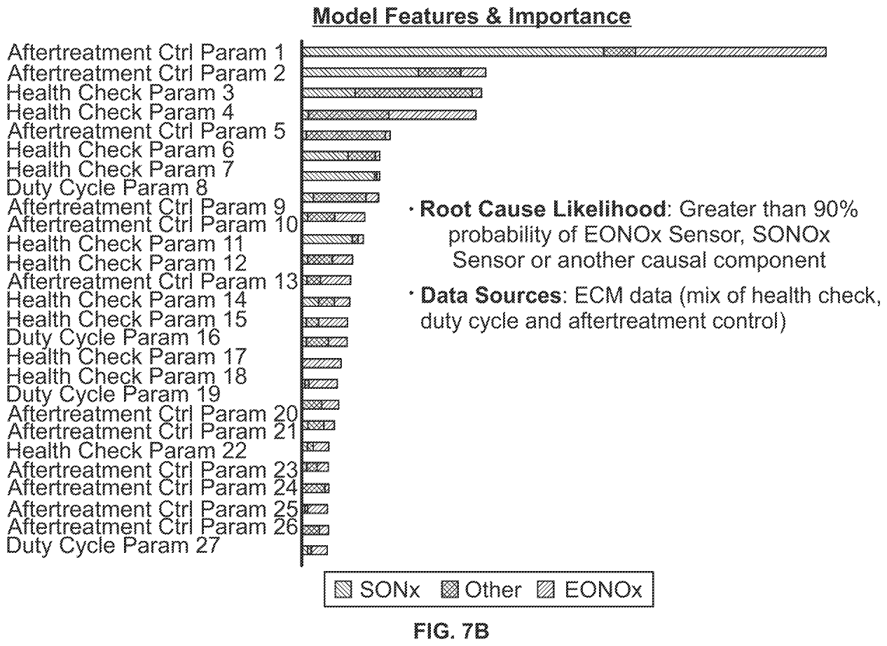

The method 600 can include the data processing system using the trained model and the in-operation data of the vehicle to generate a troubleshooting procedure for a fault in the vehicle (STEP 606). Each model can be configured to receive a corresponding subset of features of the in-operation data or trip summary data of the vehicle as input. The data processing system can determine the subset of features to be fed to the identified model. Referring to FIGS. 7A and 7B, two sets of features or parameters for distinguishing between different sets of failures are shown, according to an example embodiment. In FIG. 7A, a chart illustrating an example set of features or parameters for use with a model associated with the fault code XXXX is shown. The chart depicts the relative importance of each of the features in separating or distinguishing three different failure classes or states. In FIG. 7B, a chart illustrating an example set of features or parameters for use with a model associated with another fault code is shown. The chart depicts the importance of each of the features in separating or isolating engine out and system out NOx sensor failures.

The data processing system can use the determined subset of features as input and run or execute the model. By running the model, the data processing system can generate the troubleshooting procedure for the fault in the vehicle as output. The model can provide failure probabilities for different components associated with the fault code. The data processing system can generate the troubleshooting procedure or sequence based on the failure probabilities of the components. For instance, the data processing system can generate or create a sequence of troubleshooting steps where the first step corresponds to (e.g., designed to troubleshoot) the component with highest failure probability or likelihood, the second step corresponds to (e.g., designed to troubleshoot) the component with the second highest failure probability and so on. In other words, the troubleshooting steps can be ordered according to a decreasing order of failure probabilities of corresponding components.

The method can include the data processing system providing the troubleshooting procedure as output for use to identify a root cause of the fault in the vehicle (STEP 608). The data processing system can, for example, cause display of the troubleshooting procedure or sequence on a display device. The data processing system can provide a user interface (UI) for displaying the troubleshooting procedure. The UI can display an interactive list of troubleshooting steps. For example, the UI can provide, for each troubleshooting step, a corresponding link to access further details about that troubleshooting step. The data processing system can store the troubleshooting procedure or sequence in a memory and provide access to the stored troubleshooting procedure or sequence. The data processing system can output the troubleshooting procedure or sequence as an output file or document that can be viewed, downloaded, copied or printed. Upon receiving the troubleshooting procedure or sequence, a technician can execute the troubleshooting in the procedure according the specified order as discussed above, for example, with regard to FIGS. 1-5.

In some implementations, the data processing system can send one or more instructions to an engine control module (ECM) of the vehicle to trigger a troubleshooting step of the troubleshooting procedure or a sub-step thereof. For example, a troubleshooting step may involve starting the engine at a predefined engine speed, torque, etc. The data processing system may display, e.g., via the UI, a question to a user (e.g., technician) with regard to triggering the troubleshooting step. Upon the user confirming the triggering of the troubleshooting step, the data processing system can send an instruction or signal to the ECM to cause the ECM to take one or more actions (e.g., starting the engine, turning on the heater, actuating the gas pedal, etc.).

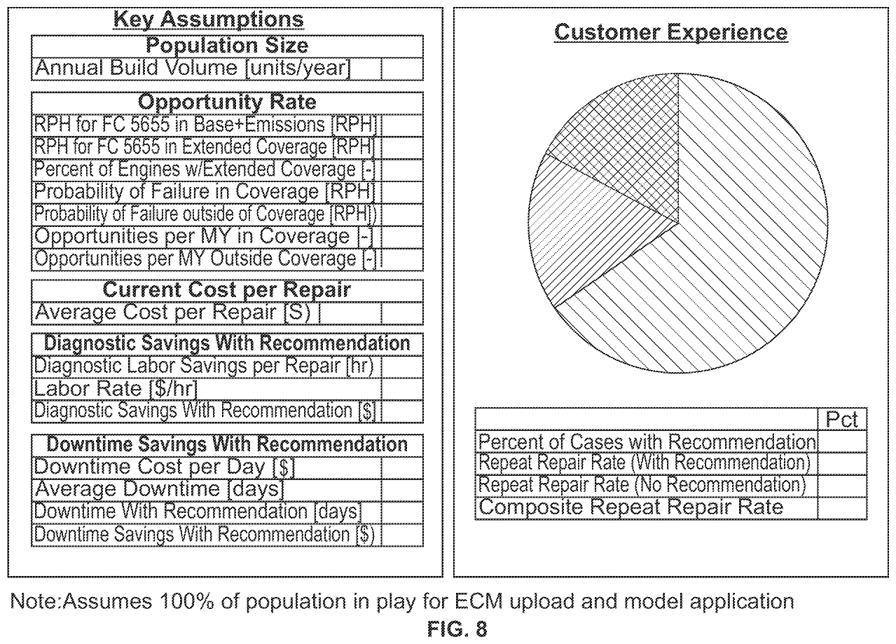

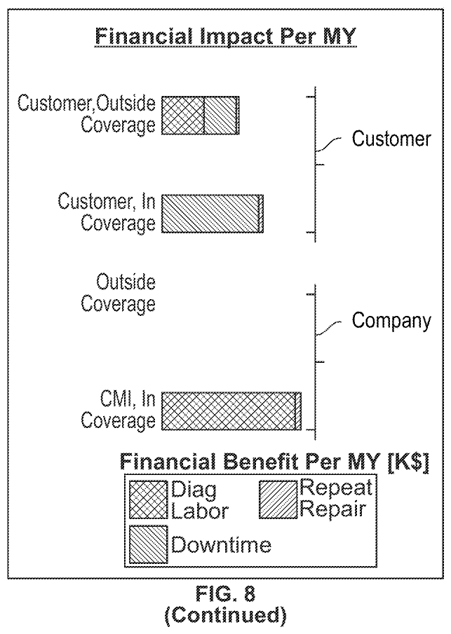

Referring now to FIG. 8, charts illustrating the financial impact as well as impact on customer experience of using the optimized diagnostic models described herein are shown. The charts may illustrate an improvement in customer experience and a reduction in cost to companies and customers.

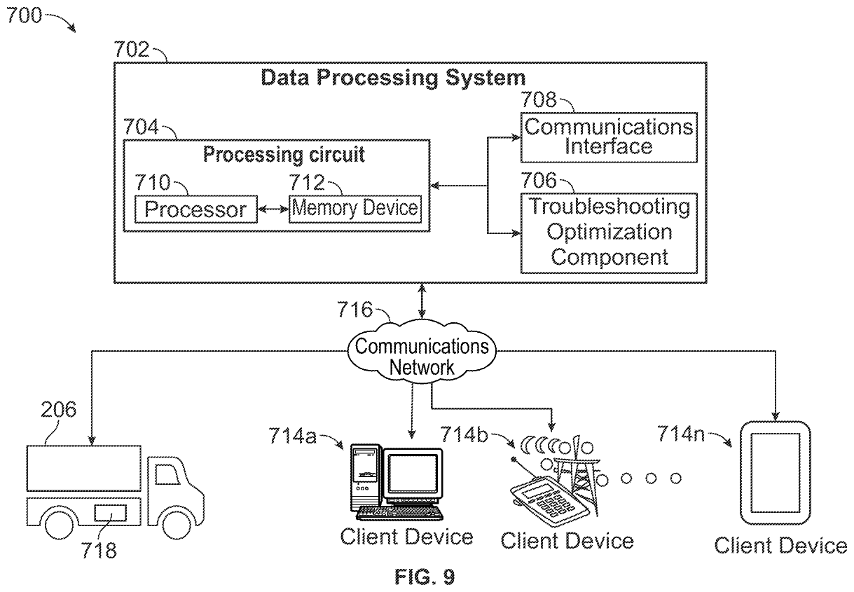

Referring now to FIG. 9, a schematic diagram of a computer environment 700 is shown, according to an example embodiment. In brief overview, the computer environment 700 can include a data processing system 702 including a processing circuit 704, a troubleshooting optimization component 706 and a communications interface 708. The processing circuit 704 can include one or more processors 710 and a memory 712. The data processing system 702 can be communicatively coupled to a plurality of client computing devices 714a-714n (referred to hereinafter either individually or in combination as client computing device 714) via a communications network 716. The data processing system 702 can be communicatively coupled to a data logging device 718 arranged in the vehicle 206.

As shown in FIG. 9, the data processing system 702 can include a processing circuit 704 having a processor 708 and a memory device 710, and a communications interface 706. The data processing system 702 can include one or more computing devices (not shown in FIG. 9), such as computer servers. The data processing system 702 can include hardware servers, virtual servers or a combination thereof. In some implementations, the data processing system 702 can be arranged in a cloud system (not shown in FIG. 9). In some implementations, the data processing system 702 can be embodied, at least partially in the vehicle 206 and/or a client computing device 714.

The troubleshooting optimization component 706 can be structured to perform the method 400 of FIG. 4, the method 600 of FIG. 6 and/or steps thereof. In one configuration, the troubleshooting optimization component 706 can be embodied as computer code instructions stored in machine or computer-readable media. The computer code instructions can be executable by a processor, such as the processor 708. As described herein and amongst other uses, the computer code instructions stored in the machine-readable media facilitate performance of certain operations to enable reception and transmission of data. For example, the machine-readable media may provide an instruction (e.g., command) to, e.g., acquire data from the client computing device(s) 714 and/or the data logging device 718. In this regard, the machine-readable media may include programmable logic that defines the frequency of acquisition of the data (or, transmission of the data). The computer-readable media may include computer-readable program code, which may be written in any programming language including but not limited to Java or the like and any conventional procedural programming languages, such as the “C” programming language or similar programming languages. The computer-readable program code may be executed on one processor or multiple remote processors. In the latter scenario, the remote processors may be coupled to each other through any type of network (e.g., CAN bus).

In another configuration, the troubleshooting optimization component 706 may be embodied as one or more circuitry components including, but not limited to, processing circuitry, network interfaces, peripheral devices, input devices, output devices, sensors, etc. In some embodiments, the troubleshooting optimization component 706 may take the form of one or more analog circuits, electronic circuits (e.g., integrated circuits (IC), discrete circuits, system on a chip (SOCs) circuits, microcontrollers), telecommunication circuits, hybrid circuits, and any other type of circuit. In this regard, the troubleshooting optimization component 706 may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on). The troubleshooting optimization component 706 may also include programmable hardware devices such as field programmable gate arrays, programmable array logic, programmable logic devices or the like. The troubleshooting optimization component 706 may include one or more memory devices for storing instructions that are executable by the processor(s) of the troubleshooting optimization component 706. The one or more memory devices and processor(s) may have the same definition as provided below with respect to the memory device 712 and the processor 710. In some hardware unit configurations, the troubleshooting optimization component 706 may be geographically dispersed throughout separate locations in a cloud system, the client computing device(s) 714 and/or the vehicle 206. Alternatively, the troubleshooting optimization component 706 may be embodied in or within a single unit/housing arranged within the cloud system.

In some implementations, the troubleshooting optimization component 706 may be fully hosted by a cloud system. In such implementations, the data logging device 718 collects vehicle data from various sensors and/or systems of the vehicle 206, e.g., on a regular basis. The data logging device 718 can transmit the collect data to the data processing system 702. As discussed above, a client computing device 714 may retrieve or copy the vehicle data from the data logging device 718 and upload the vehicle data to the data processing system 702, e.g., when the vehicle 206 comes for repair or service.

In some other implementations, the troubleshooting optimization component 706 may be at least partially hosted by the vehicle 206 and/or the client computing device(s) 714. For example, the training of optimized troubleshooting models may be implemented in the cloud while the running of the trained models may be implemented in the vehicle 206 and/or the client computing device(s) 206. The vehicle 206 and/or the client computing device(s) 206 can download the trained models and run them using the vehicle data obtained from the data logging device 718.

In the example shown, the data processing system 702 includes the processing circuit 704 having the processor 710 and the memory device 712. The processing circuit 704 may be structured or configured to execute or implement the instructions, commands, and/or control processes described herein with respect to troubleshooting optimization component 706, or to execute instructions stored in the memory device 712. The depicted configuration represents the troubleshooting optimization component 706 as a machine or a computer-readable medium including computer code instructions executable by the processor 710. However, as mentioned above, this illustration is not meant to be limiting as the present disclosure contemplates other embodiments where the troubleshooting optimization component 706, or at least a component thereof, is configured as a hardware unit. All such combinations and variations are intended to fall within the scope of the present disclosure.

The processor 710 may be implemented or performed with a single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A processor may be a microprocessor, or, any conventional processor, or state machine. A processor also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits. Alternatively or additionally, the one or more processors 708 may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The memory device 712 (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory device 712 may be communicably coupled to the processor 710 to provide computer code or instructions to the processor 710 for executing at least some of the processes described herein. Moreover, the memory device 712 may be or include tangible, non-transient volatile memory or non-volatile memory. Accordingly, the memory device 712 may include database components, object code components, script components, or any other type of information structure for supporting the various activities and information structures described herein.

The communications interface 708 can be a circuit that enables the data processing system 702 to communicate with other devices or systems, such as the client computing devices 714, the vehicle 206 and/or the data logging device 718. For instance, the communication interface 708 can receive signals indicative of the vehicle data collected by the data logging device 718. The communications interface 708 can be coupled to various vehicles 206 and/or various client computing devices 714 via the communications network 716. The communications network 716 can include the Internet, one or more wireless communications networks, one or more Wi-Fi networks, one or more local area networks (LANs), one or more wide area networks (WANs), a landline network or a combination thereof. The communication interface 708 can include a plurality of communication ports.

The client computing device(s) 714 can include a desktop, a laptop, a smartphone, a tablet device or another type of handheld device. A client computing device 714 (e.g., a handheld device) can be communicate with the data logging device 718 (or a storage device) of the vehicle 206 to retrieve vehicle data collected by the data logging device 718 and upload it to the data processing system 702. The handheld device can communicate with the data logging device 718 (or a storage device) of the vehicle 206 via wired or wireless connection such as a BLUETOOTH link, a near field communication (NFC) link, a Wi-Fi connection, or a cable connection to retrieve the vehicle data. The client computing device(s) 714 can upload the vehicle data to the data processing system via the communications network 716. Upon the data processing system 702 running the trained troubleshooting models with the vehicle data and generating a troubleshooting procedure (or a sequence of troubleshooting steps), a client computing device 714 associated with a service advisor can receive and display the troubleshooting procedure

The data logging device 718 can be communicatively connected (e.g., via wired or wireless communication links) to various sensors and/or systems of the vehicle 206. In some implementations, the data logging device 718 can query the sensors and/or systems of the vehicle 206 for measurement data, e.g., on a regular or periodic basis. In some other implementations, the sensors and/or systems of the vehicle 206 may push measured data to the data logging device 718 on a regular or periodic basis. The data logging device 718 can include or can be coupled to a storage device of the vehicle 206 to store collected vehicle data. The data logging device 718 can be configured to log information (e.g., timestamps of starting and/or switching of the vehicle engine) indicative of different trips as well as information indicative of time at which different measurements are taken by the corresponding sensors.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

While the term “processor” is briefly defined above, the term “processor” and “processing circuit” are meant to be broadly interpreted. In this regard and as mentioned above, the “processor” may be implemented as one or more application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the diagrams herein may show a specific order and composition of method steps, the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. All such modifications are intended to be included within the scope of the present disclosure as defined in the appended claims. Such variations will depend on the machine-readable media and hardware systems chosen and on designer choice. All such variations are within the scope of the disclosure.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principles of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

Accordingly, the present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A system, comprising:
a processor; and
a memory storing executable instructions, the executable instructions when executed by the processor, cause the processor to:
obtain in-operation data of a vehicle, the in-operation data including a fault code indicative of a fault in the vehicle;
identify a trained model from a plurality of trained models using the fault code;
use the trained model and the in-operation data of the vehicle to generate a troubleshooting procedure for identifying a root cause of the fault; and
provide the troubleshooting procedure as an output to identify the root cause of the fault.

2. The system of claim 1, wherein the in-operation data of the vehicle represents trip summary data.

3. The system of claim 1, wherein at least one troubleshooting step of the troubleshooting procedure comprises sending one or more instructions to a controller of the vehicle, the one or more instructions causing an engine of the vehicle to operate at a predefined engine speed or a predefined engine torque.

4. The system of claim 1, wherein the troubleshooting procedure includes a sequence of troubleshooting steps and each troubleshooting step is associated with a corresponding component of the vehicle, and wherein generating the troubleshooting procedure comprises:
determining, for each of the troubleshooting steps, a corresponding confidence probability indicative of a probability that the associated component is the root cause of the fault; and
customizing the sequence of troubleshooting steps such that the troubleshooting steps are ordered according to a descending order of confidence probabilities.

5. The system of claim 1, wherein the in-operation data of the vehicle includes at least one of engine performance data or aftertreatment system performance data.

6. The system of claim 1, wherein providing the troubleshooting procedure as the output comprises generating a user interface and causing a display device to display the user interface, and wherein the user interface comprises an interactive list of troubleshooting steps of the troubleshooting procedure.

7. The system of claim 1, wherein providing the troubleshooting procedure as the output comprises generating an output file comprising the troubleshooting procedure and retrievably storing the output file in the memory.

8. A method, comprising:
obtaining, by a data processing system, in-operation data of a vehicle, the in-operation data including a fault code indicative of a fault in the vehicle;
identifying, by the data processing system, a trained model from a plurality of trained models using the fault code;
using, by the data processing system, the trained model and the in-operation data of the vehicle to generate a troubleshooting procedure for identifying a root cause of the fault; and
providing, by the data processing system, the troubleshooting procedure as an output to identify the root cause of the fault.

9. The method of claim 8, wherein the in-operation data of the vehicle includes at least one of trip summary data, performance data, or aftertreatment system performance data.

10. The method of claim 8, wherein at least one troubleshooting step of the troubleshooting procedure comprises sending one or more instructions to a controller of the vehicle, the one or more instructions causing an engine of the vehicle to operate at a predefined engine speed or a predefined engine torque.

11. The method of claim 8, wherein the troubleshooting procedure includes a sequence of troubleshooting steps and each troubleshooting step is associated with a corresponding component of the vehicle, and wherein generating the troubleshooting procedure comprises:
determining, for each of the troubleshooting steps, a corresponding confidence probability indicative of a probability that the associated component is the root cause of the fault; and
customizing the sequence of troubleshooting steps such that the troubleshooting steps are ordered according to a descending order of confidence probabilities.

12. The method of claim 8, wherein at least one troubleshooting step of the troubleshooting procedure comprises sending one or more instructions to a controller of the vehicle, the one or more instructions causing an engine of the vehicle to operate at a predefined engine speed or a predefined engine torque.

13. The method of claim 8, wherein providing the troubleshooting procedure as the output comprises generating a user interface and causing a display device to display the user interface, and wherein the user interface comprises an interactive list of troubleshooting steps of the troubleshooting procedure.

14. The method of claim 8, wherein providing the troubleshooting procedure as the output comprises generating an output file comprising the troubleshooting procedure and retrievably storing the output file in a memory of the data processing system.

15. A non-transitory computer readable medium having computer executable instructions embodied therein that, when executed by one or more processors of a computing system, cause the computing system to:
obtain in-operation data of the vehicle, the in-operation data including a fault code indicative of a fault in the vehicle;
identify a trained model from a plurality of trained models using the fault code;
generate a troubleshooting procedure for identifying a root cause of the fault based on the trained model and the in-operation data of the vehicle; and
provide the troubleshooting procedure as an output to identify the root cause of the fault.

16. The medium of claim 15, wherein the in-operation data of the vehicle includes trip summary data.

17. The medium of claim 15, wherein the troubleshooting procedure includes a sequence of troubleshooting steps and each troubleshooting step is associated with a corresponding component of the vehicle, and wherein generating the troubleshooting procedure comprises:
determining, for each of the troubleshooting steps, a corresponding confidence probability indicative of a probability that the associated component is the root cause of the fault; and
customizing the sequence of troubleshooting steps such that the troubleshooting steps are ordered according to a descending order of confidence probabilities.

18. The medium of claim 15, wherein the in-operation data of the vehicle includes at least one of engine performance data or aftertreatment system performance data.

19. The medium of claim 15, wherein providing the troubleshooting procedure as the output comprises generating a user interface and causing a display device to display the user interface, wherein the user interface comprises an interactive list of troubleshooting steps of the troubleshooting procedure.

20. The medium of claim 15, wherein providing the troubleshooting procedure as the output comprises generating an output file comprising the troubleshooting procedure and retrievably storing the output file in a memory.
